(19) United States
(12) Patent Application Publication
(10) Pub. No.: US 2005/0086513 A1
(43) Pub. Date: Apr. 21, 2005

(54) Concept based message security system

(75) Inventor: Daniel M. Foody, Mountain View, CA (US)

Correspondence Address: FITZPATRICK CELLA HARPER & SCINTO, 30 ROCKEFELLER PLAZA, NEW YORK, NY, 10112, US

(73) Assignee: ACTIONAL CORPORATION, MOUNTAIN VIEW, CA (US)

(21) Appl. No.: 10/945,919

(22) Filed: Sep. 22, 2004

Related U.S. Application Data
(60) Provisional application No. 60/506,517, filed on Sep. 29, 2003.

(51) Int. Cl. H04L 9/00

(52) U.S. Cl. 713/200

(57) ABSTRACT

In a message communication arrangement, plural concept items relating to a message type are generated for message elements and a security policy is assigned to each concept item. Each message element of a message identified with one of the concept items is processed according to the security policy assigned to the identified concept item. The identification of the message elements with the concept items is performed independently of the assignment of security policies to the concept items.

This application claims the benefit of U.S. Provisional Application No. 60/506,517, filed Sep. 29, 2003.

### FIELD OF THE INVENTION

The invention relates to electronic messaging and, more particularly, to arrangements for secure transmission of electronic messages over networks.

### BACKGROUND OF THE INVENTION

As is well known, most commercial transactions are performed using electronic messaging between remote locations. In electronic fund transfers (EFT), an electronic message transmitted over a network is used to transfer money from an account at one institution to a different account at another institution. Credit card usage by consumers and others generally requires electronic messages between the point of sale and a financial institution over a network. Processing of applications for loans and of commercial contracts may also use electronic messaging over networks to provide communication of documents and payments between remote locations. In order to assure confidentiality and integrity in these transactions, electronic messages conveying private information may be encrypted and/or digitally signed prior to transmission and decrypted and signature validated after receipt to assure privacy and integrity.

In conducting transactions over networks, it has been the policy of many institutions to require the encryption and/or digital signature processing of an entire electronic message. Digital signing as disclosed in U.S. Pat. No. 5,748,738 issued to S. F. Bisbee et al. May 8, 1998 includes applying a hash function to an electronic message or document to form a message digest. A cryptographic key is applied to the message digest to produce a digital signature. When the encryption and/or digital signature policy is applied to an electronic message as a whole, e.g., a tax return, the encryption and signing of the entire tax return requires extensive processing although it is probably sufficient to encrypt only personal information while providing a digital signature over the entire tax return. In other electronic message type transactions, encryption and digital signatures need only be applied selectively to electronic messages.

With the introduction of Web services such as XML-Signature (http://www.w3.org/TR/xmldsig-core/), XML-Encryption (http://www.w3.org/TR/xmlenc-core/), and WS-Security (http://msdn.microsoft.com/library/default.asp?url=/library/en-us/dnglobspec/html/ws-security.asp), individual parts or elements of an electronic message may be treated differently with respect to security policies. In view of the high computational expense of security processing and the extensive use of security processing, limiting the security processing to only the parts of a message that require privacy and/or integrity significantly improves performance. It also allows multiple parties to construct a message with each party securing its portion of the message according to its requirements. For example, an electronic message of a price quote may be generated with a sales representative's digital signature and a manager's approval may be attached to the price quote with the manager's digital signature. Accordingly, security at the message element level provides significant advantages.

U.S. Pat. No. 6,609,200 issued Aug. 19, 2003 to Anderson et al. discloses an arrangement in which a document type is determined according to its constituent parts and the document structure. The document is separated into blocks and a digital signature is assigned to one or more of the blocks to which a start tag and end-tag are assigned. The structuring of message security software for a message type using element-level security involves developing the software by a developer with knowledge of message elements of the message type so that security measures can be assigned to the elements and the administration of security is generally performed independently of the development. Since the applicable security measures may change after the software is put in use, a security administrator must keep track of the security policy and security measures for each of a large number of message elements and coordinate changes therein with the development group. As a result, it is a problem in electronic message security that the management of message security on an element-by-element basis is significantly more complex than management on a message-level security basis.

### BRIEF SUMMARY OF THE INVENTION

The invention is directed to a security arrangement for transmission of messages over a network in which a security policy may be applied to individual elements of a message transmitted over a network wherein the administration of security is simplified.

According to one aspect of the invention, an electronic message has one or more elements. Each message element is associated with a concept item that is associated with a set of message elements. A security policy is defined for the associated concept item and is applied to the message elements of the set to provide predetermined security commands to the message elements.

According to another aspect of the invention, a concept repository storing concept items defining classes of message elements, a security policy repository storing definitions of security measures for the stored concepts items and a message element association repository storing associations between the concept items and the message elements are formed for all messages of a message type. The security policy repository stores one or more of an encryption command and an integrity command, a no action or other commands for each concept item. Prior to transmitting a message of the message type, a concept item may be selected in the message element association repository for an element of the message and the security policy for the security policy associated with the selected concept item are applied to the message element from the security policy repository. If there is privacy requirement in the security policy repository, an encryption command is issued from the security policy repository, the message element is encrypted. If an integrity requirement is issued from the security policy repository, the message element is digitally signed.

According to yet another aspect of the invention, each record in the security policy repository includes a privacy and/or integrity requirement. In receiving a message of the message type, a concept item is selected from the message element association repository for elements of the message and the security policy commands for security policy associated with the concept item are selected from the security policy repository. If a privacy requirement is issued from the security policy repository, the message element is decrypted. If an integrity requirement is issued from the security policy repository, the digital signature of the message element is validated.

In an embodiment of the invention, a transmitting message terminal has a security engine module. In the security engine module, a concept item repository stores plural concept items each defining a class of message elements for a message type. A security policy repository stores one or more security commands of a security policy for each concept item and a message element association repository stores an association of each message element with the concept item of the message element class. Prior to transmitting a message, the security engine module processes the message by selecting a concept item for one or more message elements in the message element association store. The selected concept item addresses the security policy repository and the security requirements of the security policy associated with the concept item are retrieved. In response to a privacy requirement from the security policy module, the message element is encrypted. In response to an integrity requirement from the security policy module, the message element is digitally signed and in response to neither requirement from the security policy module, the message element is unaltered.

In another embodiment of the invention, a security engine module in a receiving message terminal has a concept item repository that stores plural concept items each defining a class of message elements for a message type, a security policy repository that stores one or more security requirements of a security policy for each concept item and a message element association repository stores an association of message elements with the concept items for the message element class. The security requirements include a privacy requirement, an integrity requirement and a no security requirement. After a message is received, message elements are processed by the security engine module. In the security engine module processing of a message element, a concept item is selected from the message element association store as addressed by the message element. The selected concept item addresses an associated security policy in the security policy repository. The message element is processed by the security engine module in response to the security requirements of the addressed security policy. In response to a privacy requirement from the security policy module, the message element is decrypted. In response to an integrity requirement from the security policy module, the digital signature of the message element is validated and in response to a no security requirement from the security policy module, the message element is unaltered. The clear message from the security engine module is then made available through the receiving message terminal.

### BRIEF DESCRIPTION OF THE DRAWINGS

FIG. 1 is a general flow diagram illustrating the invention;

FIG. 2 is a flow chart showing an arrangement to generate a security application for use in a security message processing engine;

FIG. 3 is a block diagram of a message transfer arrangement for a network using security engine modules according to an embodiment of the invention;

FIG. 4 is a flow chart that illustrates the operation of a security engine module in a transmitting message terminal according an embodiment of the invention;

FIG. 5 is a flow chart showing the security processing of a message element to be transmitted of a network in accordance with an embodiment of the invention;

FIG. 6 is a flow chart illustrating a routine for finding a concept item for a message element according to an embodiment of the invention;

FIG. 7 is a flow chart illustrating a routine for encrypting and/or digitally signing a message element according an embodiment of the invention;

FIG. 8 is a flow chart illustrating a routine for security processing a sub-element according to an embodiment of the invention;

FIG. 9 is a flow chart showing the security processing of a message received by a security engine module in a receiving message terminal according to an embodiment of the invention;

FIG. 10 is a flow chart showing security processing of a message element received from a network in accordance with an embodiment of the invention;

FIG. 11 is a flow chart illustrating a routine for decrypting and/or validating a digital signature of a message element according an embodiment of the invention;

FIG. 12 is a flow chart illustrating a routine for security processing a sub-element according to an embodiment of the invention;

FIG. 13 is a block diagram of a message terminal in accordance with the invention; and

FIG. 14 is a block diagram of an administrative processor that provides information to message terminals for security processing.

### DETAILED DESCRIPTION

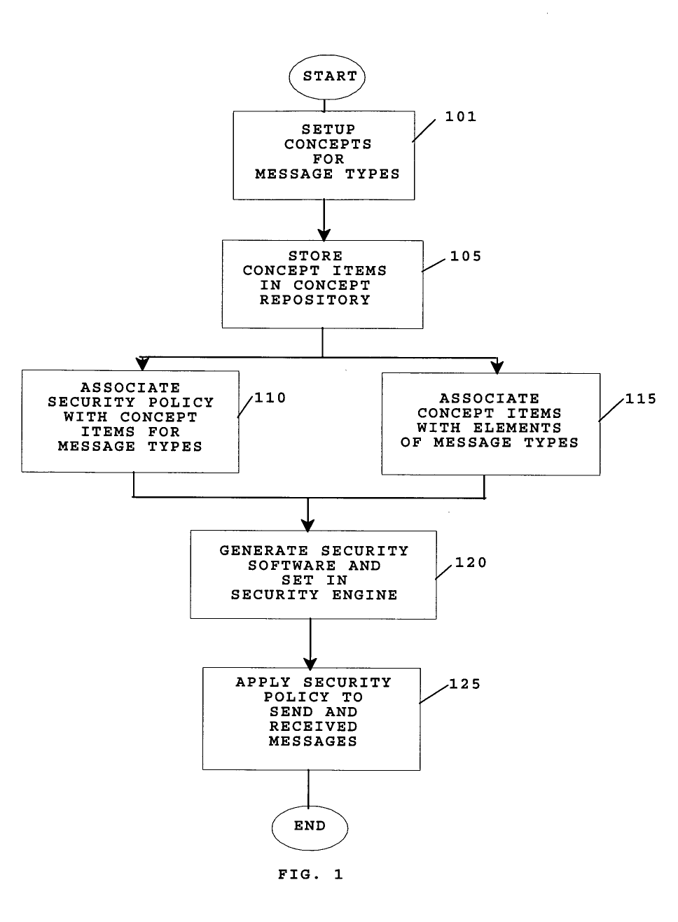

In the administration of transactions over electronic networks, different security processing may be assigned to different elements of an electronic message. FIG. 1 shows an arrangement in which a set of concepts each defining a class of message elements is formed. A security policy is associated with each concept and the elements of a message type are associated with the concepts. The concepts, the security policies for the concepts and the elements associated with the concepts are stored in a security module of message transmitters and message receivers. Security processing is arranged so that a security administrator need not keep track of all the message elements of all message types but can control security of all the message elements by accessing and modifying the concepts associated with the message elements rather than the message elements themselves.

In FIG. 1, the concepts for message types are set up in step 101. In step 110, a security policy is assigned to each of the set up concepts. The security policy may include security requirements such as a privacy requirement involving encryption and decryption, an integrity requirement involving digital signing and validation or no security requirement. Independent of the assigning of security policies to the concepts, each concept is associated with one or more message elements in step 115. Security software based on the use of security policies for concepts that are associated with message elements is then transferred to security engine module (step 120) of message terminals and the concept based software is used by the message terminals for sending and receiving messages (step 125).

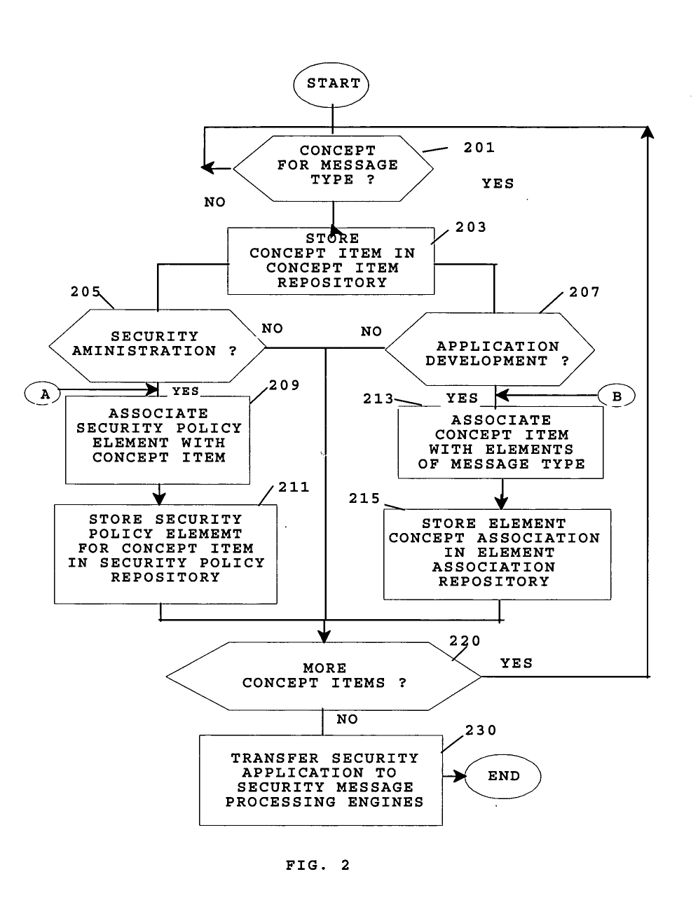

A flow chart of an arrangement for forming a concept based security engine is shown in FIG. 2. The steps of FIG. 2 may be performed in an administrative processor arrangement such as shown in FIG. 14 wherein the processing is performed in an administrative processing unit 1410 and the results of the processing are stored in a concept repository 1420, an element association repository 1430 and a security policy repository 1440.

Referring to FIG. 2, a concept item is stored in a concept repository in step 203 in response to a message concept being received in a decision step 201. In step 207, it is decided if the concept item is to be processed for application development. If yes, the concept item is associated with one or more elements of a message type in step 213. Otherwise, the decision step 220 is entered. A step 215 is entered from the association step 213 in which the element association is stored in an element association repository and the decision step 220 is entered. Independent of the processing in the steps 207, 213 and 215, a security administration decision step 205 is entered from the concept item storage step 203. If yes in the step 205, a security policy element is associated with the concept item in step 209 and the associated security policy element is stored in a security policy repository in step 211. Upon completion of storage of a security policy element for the concept item in the step 211 and the storage of the element-concept association in the step 215, whether more concept items are to be processed is decided in the step 220. If yes, the step 201 is reentered. If no, the security program application with the concepts processed from the step 201 through 220 is transferred to a security message processing engine in the message terminals of a network. The step 209 for associating security policies with concept items may be entered directly for security administration through an entrance point A and the step 213 for associating message elements with concept items may be entered directly through an entrance point B.

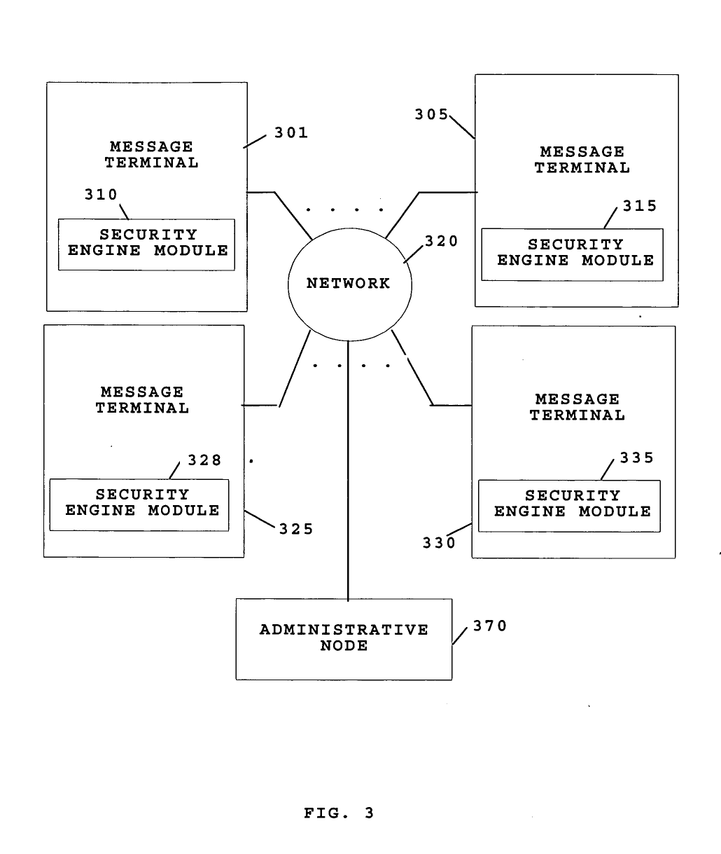

FIG. 3 shows an arrangement for exchanging messages over a network. The arrangement of FIG. 3 includes a network 320 to which message terminals 301, 305, 325 and 330 and an administrative node 370 are connected. Each message terminal includes a security engine module operative to apply security policies to messages in both message sending and receiving modes. Each security engine module has a concept repository that stores concept items for message types, an element association repository that stores the associations between concept items and message elements and a security policy repository that stores security commands to be applied to each concept item.

As an example of messages communicated among the message terminals of FIG. 3, the message types used by a credit reporting agency will be considered. A credit reporting agency generally uses message types such as credit check requests, credit check replies, close account and change of address. A credit card request message type in XML (Extensible Markup Language) is shown in Table 1.

TABLE 1

```
<CreditCheckRequest>
  <Identity>
    <Name>John Q. Public III</Name>
    <Address>
      <Street>126 Village Lane</Street>
      <City>Smallville</City>
      <State>CA</State>
      <Zip>12433</Zip>
    </Address>
    <SSN>123-12-1234</SSN>
  </Identity>
  <Payment xsd:type=“CreditCard“>
      <Name>John Q. Public</Name>
      <Number>1234123412341234</Number>
      <Type>MasterCard</Type>
      <Expiry>06-2004</Expiry>
  </Payment>
</CreditCheckRequest>
```

Table 2 illustrates a concept item repository that may be formed in the step 203 of FIG. 2 for the credit check message type.

TABLE 2
Concept Repository

| CONCEPT | CONCEPT ITEM | |
|---|---|---|
| NAME | IDENTIFIER | DESCRIPTION |
| SOCIAL SEC. | Soc_Sec | SOCIAL SECURITY NUMBER |
| NUMBER | | OF AN INDIVDUAL |
| PERSONAL | Pers_ID | PERSONAL IDENTIFICATION |
| IDENTITY | | INFORMATION TO |
| | | VALIDATE AN |
| | | INDIDUAL IDENTITY |
| CHARGE | Chrg_Det | BILLING DETAILS TO |
| DETAILS | | CHARGE INDIVIDUAL |
| | | FOR USE OF CREDIT |
| | | REPORTING SERVICE |

The credit card request message type includes the elements Identity and Payment. The element Identity has sub-elements Name, Address and SSN. The element Address has sub-elements Street, City, State and Zip and the element Payment is of type “Credit Card” and has sub-elements Name, Number and Expiry. The concept items Soc_Sec, Pers_ID and Chrg_Det applicable to the credit card request message type are stored in the concept item repository of the security engine module. Table 3 illustrates an element association repository for the credit card request message type.

TABLE 3
Element Association Repository

| | ELEMENT | CONCEPT | MESSAGE | ELEMENT |
|---|---|---|---|---|
| ELEMENT | TYPE | ITEM | TYPE | LOCATOR |
| SSN | | Soc_Sec | CREDIT | /Creditcheck- |
| | | | CHECK | request/ |
| | | | REQUEST | identity/SSN |
| Identity | | Pers_ID | CREDIT | /Creditcheck- |
| | | | CHECK | request/identity |
| | | | REQUEST | |
| Payment | CREDIT | Chrg_Det | CREDIT | Creditcheck- |
| | CARD | | CHECK | request/ |
| | | | REQUEST | Payment |

In table 3, the message element SSN of the credit card request message type is associated with the concept item Soc_Sec. The message element Identity is associated with the concept item Pers_ID and the Payment element is associated with the Chrg_Det concept item. The location of the SSN, Identity and Payment elements in the message type is also entered into the element association repository.

Table 4 illustrates the security policy repository for the credit card request message type.

TABLE 4
Security Policy Repository

| SECURITY | | CONCEPT | PRIVACY | INTEGRITY |
|---|---|---|---|---|
| POLICY | CONCEPT | ITEM | REQUIRED | REQUIRED |
| ssn | SOCIAL | Soc_Sec | YES | NO |
| | SECURITY | | | |
| | NUMBER | | | |
| PI | PERSONAL | Pers_ID | NO | YES |
| | IDENTITY | | | |
| C_D | CHARGE | Chrg_Det | YES | YES |
| | DETAILS | | | |

As indicated in Table 4, the security policy ssn for the social security concept item Soc_Sec requires only privacy; the security policy PI for the concept item Pers_ID for personal identity requires only integrity. The charge details concept item Chrg_Det requires both privacy and integrity. In message transmission, when the ssn security policy is applied in message transmission, the message element SSN is encrypted. When the PI security policy is applied, the element Identity and its sub-elements Name, Address and SSN and the sub-elements of the Address sub-element Street, City, State and Zip are digitally signed. When the C_D security policy is applied, the Payment element and its sub-elements Name, Number and Expiry of the Payment element are both encrypted and digitally signed.

In message receiving, the digital signature for the element Identity and its sub-elements Name, Address and SSN and the sub-elements of the Address sub-element Street, City, State and Zip is validated when the PI security policy is applied. The Payment element and its sub-elements Name, Number and Expiry of the Payment element are decrypted when the C_D security policy is applied. The Payment element and its sub-elements Name, Number and Expiry are decrypted and the digital signature is validated when the C_D security policy is applied.

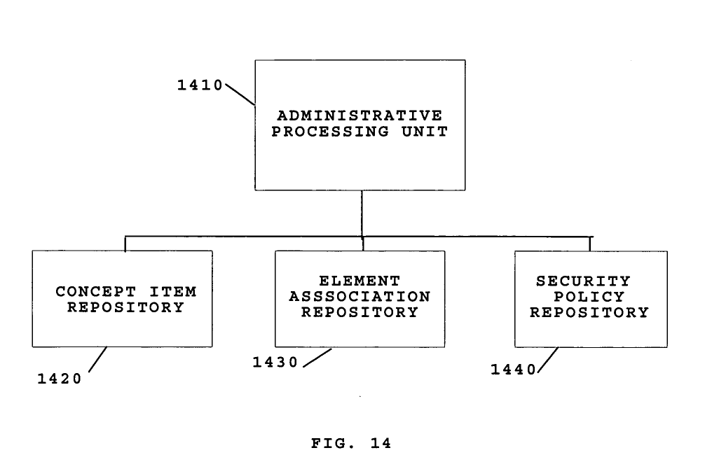

A block diagram of a processing arrangement used as a message terminal of FIG. 3 is shown in FIG. 13. The processing arrangement of FIG. 13 includes a processing unit 1301, a bus 1303, a memory 1305, a network interface 1315, a security engine module 1310 with associated concept repository 1320, element association repository 1330 and security policy repository 1340, and an input-output device 1318. Each of the processing unit 1301, the memory 1305, the network interface 1315, the input-output device, the security engine module 1310 and the input-output device are interconnected through the bus 1303 and the network interface is connected to the network 320. The concept item repository 1320 stores the records shown in Table 2 for all message types used by the message terminal. The element association repository 1330 stores the message-concept item association records shown in Table 3 for all message types and the security policy repository stores the security policy records shown in Table 4 for all message types. The records from the concept item repository, the element association repository and the security policy repository are used in the security engine module 1310.

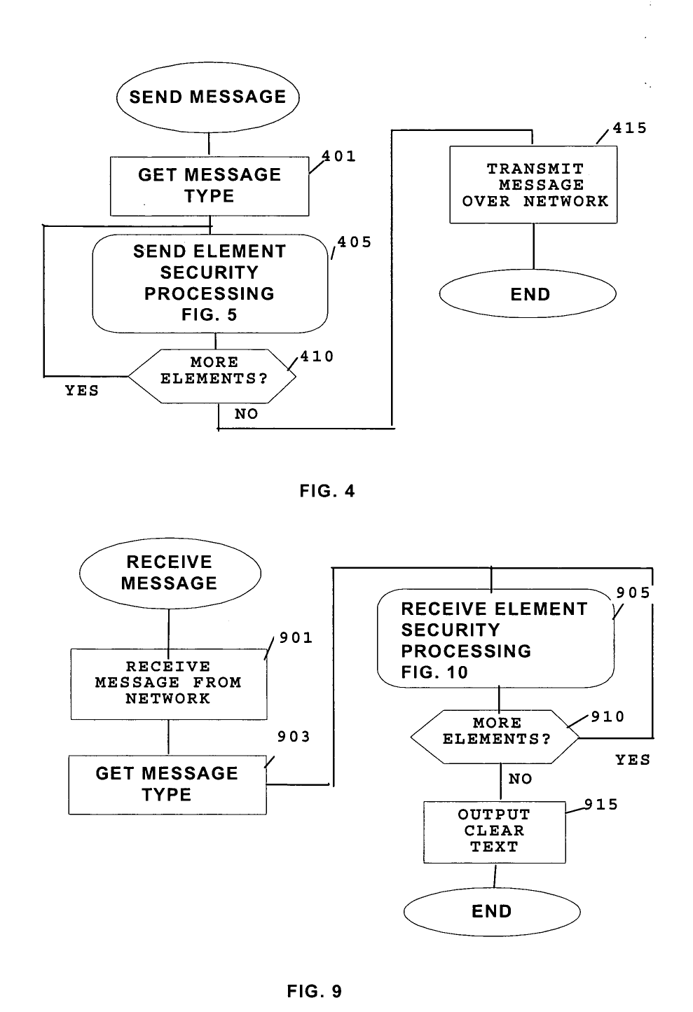

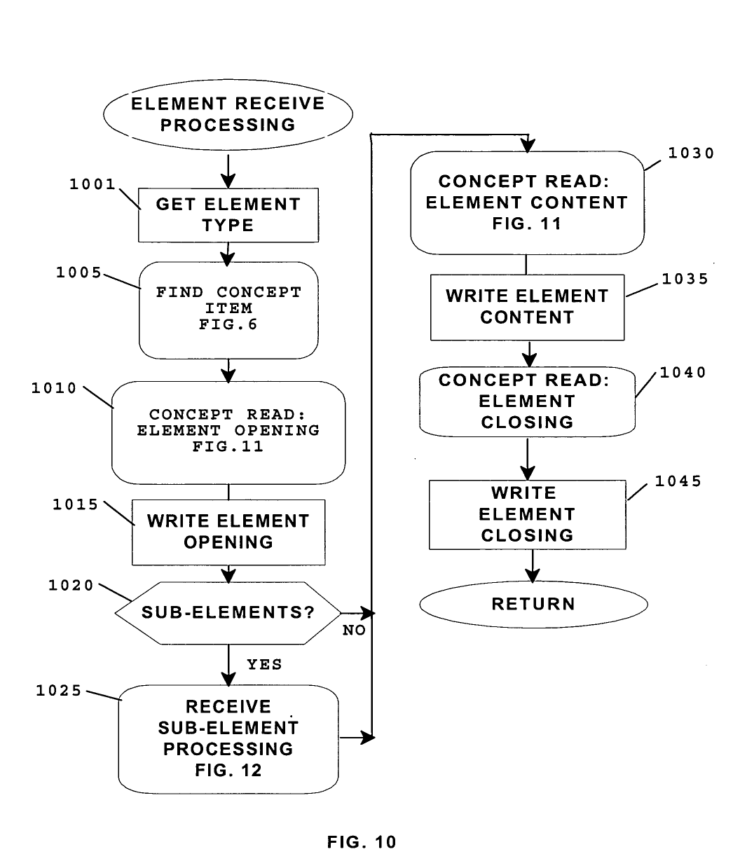

In a send operation, information for a message type is inputted to the processing unit 1301 of the message terminal through the input-output device 1318 and is stored in the memory 1305. The security engine module 1310 operates in accordance with the flow chart of FIG. 4 to produce a secure message from the inputted information of a prescribed message type. The secure message formed in the message terminal is outputted to the network 320 through the network interface 1315. In a receive operation, a secure message received by the network interface 1315 is stored by the processing unit 1301 in the memory 1305. The security engine module 1310 operates in accordance with the flow chart of FIG. 9 to convert the secure message to a clear message and the clear message is output by the input-output device 1318.

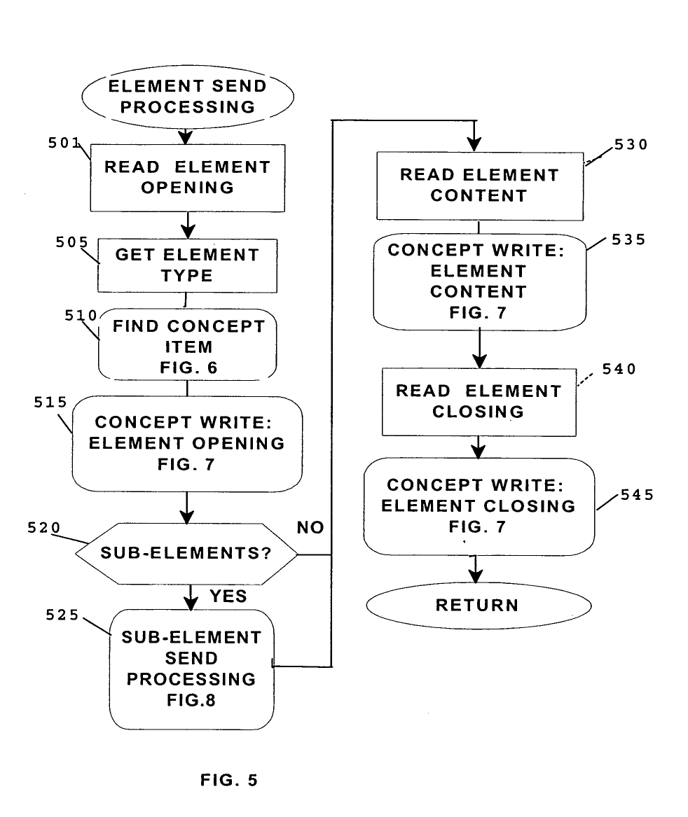

FIG. 4 illustrates the operation of the security engine module of FIG. 3 in processing a message to be sent over the network 320 with respect to security. Referring to FIG. 4, step 401 is entered in which the message type of a message to be sent is obtained. Send element security processing of FIG. 5 is then performed for the next element of the message type in step 405. Upon completion of the element processing, it is decided whether there are more elements in the message type for processing in a step 410. If yes, the step 405 is reentered. Otherwise, the security processing of the message is complete and the message is sent by the message terminal in step 415.

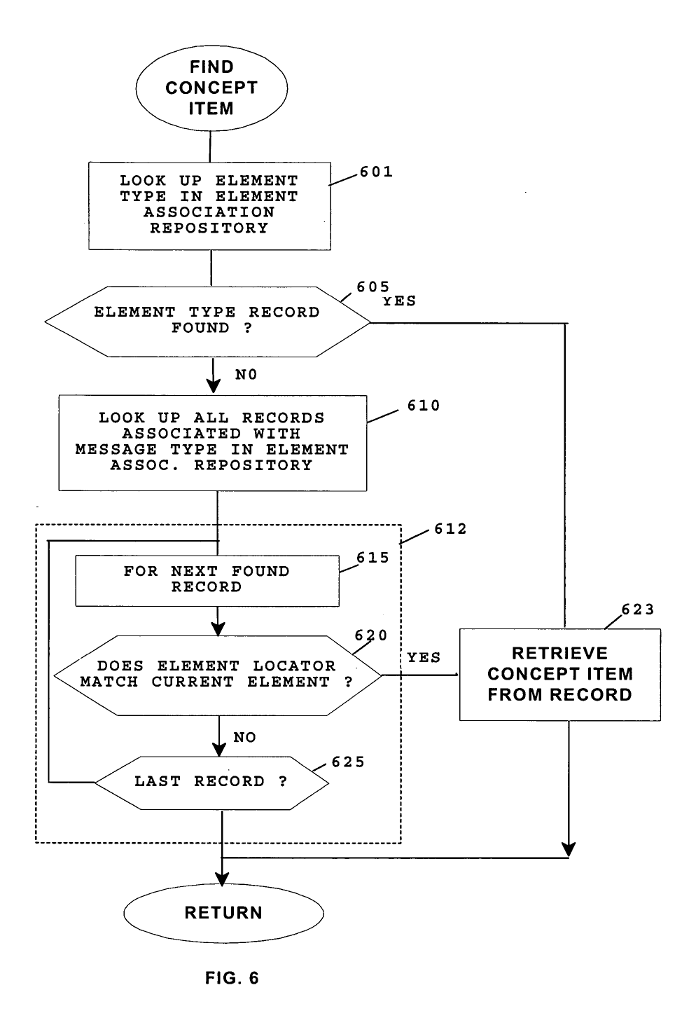

Referring to FIG. 5, the send element security processing is started by reading the first element opening. For the message type CreditCheckRequest shown in Table 1, the element “Identity” is read in a step 501. No element type is found in the element association repository (Table 3) in a step 505. A step 510 is then entered to call the find concept item routine of FIG. 6 to find the concept item applicable to “Identity” opening. In a step 601 of FIG. 6, the element association repository is searched for an Identity element type. No Identity element type is found in the element association repository (Table 3) and a step 610 is entered through decision step 605. All records for the message type CreditCheckRequest in the element association repository are searched in a step 610.

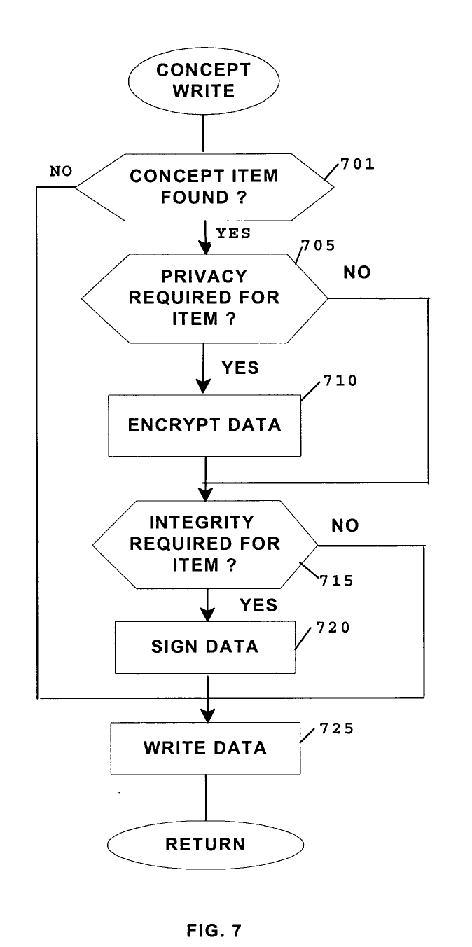

In the loop 612, each successive record for CreditCheckRequest is compared with the element locator of the record (step 620). If a match is found, the concept item for the element is retrieved in step 623 and step 515 in FIG. 5 is entered which calls the concept write routine of FIG. 7 for the Identity concept opening. If an element type record is found in the decision step 605, the associated concept item is retrieved and the step 515 is entered. Since no element type is found in the element association repository for the identity element but the element Identity matches the locator /CreditCheckRequest/identity in the step 620, the concept item Pers_ID is retrieved in the step 623.

In the step 515, a concept write routine illustrated in FIG. 7 is called. In FIG. 7, it is decided in a step 701 whether a concept item has been found. If not, the data of the element is written to the message terminal in step 725 and control is returned to a step 520 in FIG. 5. If yes, it is decided whether privacy is required for the concept item by the security policy in a step 705. If privacy is required, the data content of the element is encrypted in a step 710. Encryption may be performed using XML Encryption. Control is passed from either the step 705 or the step 710 to step 715 in which the requirement of integrity for the concept item by the security policy is decided. If yes in the step 715, the data content of the message element is digitally signed. The signature may be formed using XML Signature. The encrypted and/or signature of the element is written to the message terminal for transmission in a step 725 and control is returned to the step 520.

With respect to the element identity, it is recognized in the step 701 that a concept item “Pers_ID” was found. In accordance with the security policy for the concept “Pers_ID”, integrity is required for the element “identity”, its sub-elements Name, Address and SSN and the sub-elements Street, City, State and Zip of the sub-element Address. There is, however, no content for the element opening of the identity element. Accordingly, no data signing is performed in the step 720 and control is returned to step 520 in FIG. 5.

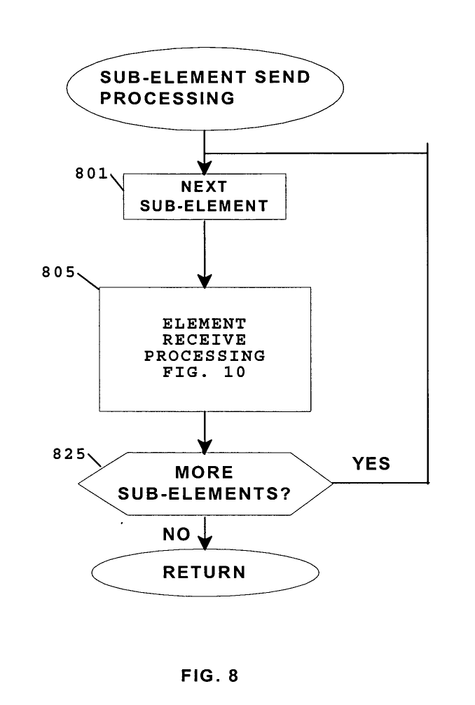

If a sub-element is recognized in the step 520, control is passed to the sub-element send processing routine of FIG. 8. In FIG. 8, the Name sub-element of the “identity” element is addressed in step 801 and the Name sub-element is processed according to the element send processing routine of FIG. 5 in step 805. During the element read processing, a search for a sub-element type for the Name sub-element is made in the element association repository but is not found for the sub-element opening, content or closing. In the concept find processing of FIG. 6 for the sub-element Name, no element type is found in step 605. The records of the element association repository are then searched in the loop 612. No match with an element locator is found in the step 620 so that there is no encryption or digital signing for the sub-element “Name” in a concept write routine.

The step 801 is reentered from the step 805 through the more sub-element decision step 825 and the next sub-element Address is recognized. Since there is no sub-element type for the sub-element Address and there is no concept item for the sub-element Address, there is no security processing in the concept write routine of FIG. 7 for this sub-element. Similarly, there are no entries in the element association repository for the sub-elements Street, City, State and Zip of the “Address” sub-element and no privacy or integrity processing is performed for these sub-elements in the element send processing of FIG. 5.

After the Address sub-element is processed in the flow chart of FIG. 8, the next sub-element SSN is addressed in the step 801 and is processed in the step 805. No sub-element type is found for the sub-element SSN. During the record searching of the loop 612 in the concept find processing of FIG. 6, an element locator /CreditCheck/Identity/SSN is found in the element association repository in the step 620 and the concept item Soc_Sec is retrieved in the step 623. The concept write routine for the content of the SSN sub-element is performed in FIG. 7. After the recognition of the Soc-Sec concept item in the step 701, it is determined from the security policy repository that only privacy is required for this sub-element. The encrypt data step 710 is entered through the privacy decision step 705. The SSN sub-element data is encrypted in the step 710 and the encrypted data is written to the message terminal in the step 725 through the steps 715 and 725.

No more sub-elements are found for the Identity element in the decision step 825. Control is returned to the step 530 in which the content of the Identity element including all sub-elements is read. The concept write for the content of the Identity element including all of its sub-elements is then performed in FIG. 6 for the step 535. As indicated for the PI (personal identity) entry in the security policy repository (Table 4), only integrity processing is required for the concept item Pers_ID. In the concept write processing for the “Identity” element, the sign data step 720 is entered from the integrity required decision step 715 and a digital signature for the entire “Identity” element content including the content of its sub-elements Name, Address and SSN and the sub-elements of the Address sub-element Street, City, State and Zip is generated. The digitally signed data is then written to the message terminal for transmission.

After completion of the concept write for the Identity element content in the step 535, the element closing of the “Identity” element is read in a step 540. Since there is no content for the Identity element closing, no action is taken in FIG. 7 for the concept write of the identity element closing in the step 545. Control is returned to a decision step 410 in FIG. 4 and the send element security processing of FIG. 5 is reentered from the step 410 for the element “Payment” in the CreditCheckRequest message. The “Payment” element is of the xsd (XML schema description) element type “CreditCard” which is associated with the concept item Chrg_Det in the CreditCheckRequest message type. The element type CreditCard is obtained in the step 505 after the “Payment” element opening is read in the step 501 of FIG. 5. In the find concept item of FIG. 6 for the step 510, the element type CreditCard is found in the step 605 and the associated concept item Chrg_Det is obtained from the element association repository (Table 3) in the step 620. The concept item Chrg_Det is then retrieved in the step 623 and control is then passed to the step 515 in FIG. 5.

A concept write operation of FIG. 7 is performed on the “Payment” element opening in the step 515. Since there is no content for the “Payment” element opening, no action is taken in the routine of FIG. 7 in the step 515 and the existence of the sub-elements Name, Number, Type and Expiry of the “Payment” element is detected in the decision step 520. The sub-element send processing for these sub-elements is then performed in FIG. 8. None of the sub-elements Name, Number, Type and Expiry has an element type or an associated concept item in the element association repository and no privacy or integrity processing is performed for these sub-elements during the element send processing performed in the routine of FIG. 5 for the sub-elements addressed in FIG. 8. After processing the last sub-element Expiry, control is returned to the step 530 through the decision step 825 and the content of the “Payment” element, i.e., that of the sub-elements Name, Number, Type and Expiry is read.

In the concept write step 535, the step 701 is entered in which the concept type Chrg_Det is found for which the associated security policy for the element type CreditCard in the security policy repository requires both privacy and integrity. The step 710 is entered from the decision step 705 and the content data in the sub-elements Name, Number, Type and Expiry is encrypted. The step 720 is then entered through the decision step 715 and the data of the sub-elements Name, Number, Type and Expiry of the Payment element is digitally signed. The resulting encrypted and digitally signed data is then written to the message terminal for transmission and control is returned to the step 540 in FIG. 5. After the concept write for the “Payment” element content in the step 535, the element closing of the “Payment” element is read in step 540. Absent content in the “Payment” element closing, no privacy or integrity processing is performed in FIG. 7 for the concept write of the “Payment” element closing and control is returned to a decision step 410 in FIG. 4. No other elements are detected in the decision step 410 and the message is transmitted over the network in a step 415.

When a message terminal receives a message, it enters into the operations shown in the flow chart of FIG. 9. In a step 901, the message type, e.g., CreditCheckRequest is obtained from the message. The receive element security processing routine of FIG. 10 is then entered for the first message element, “Identity”.

In a receive operation, a secure message received by the network interface 1315 is stored by the processing unit 1301 in the memory 1305. The security engine module 1310 operates in accordance with the flow chart of FIG. 9 to convert the secure message to a clear message and the clear message is output by the input-output device 1318. In FIG. 9, the message is received in a step 901 and the message type is obtained in a step 903. The receive element security processing routine of FIG. 10 is successively called for the elements of the message in step 905. When there are no more elements to be processed in a step 910, the clear message is output from the input-output device 1318 in FIG. 13 (step 915).

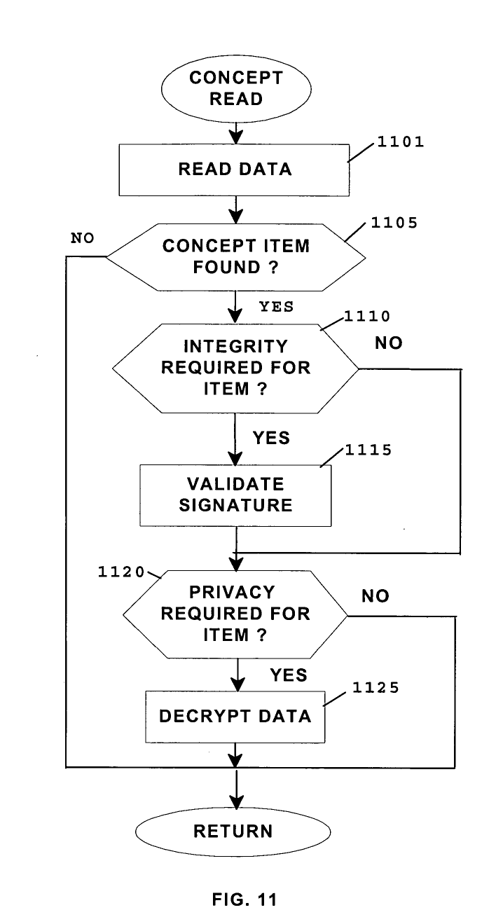

Referring to FIG. 10, the receive element security processing is started by reading the first element opening. For the message type CreditCheckRequest of the received message, the first element is Identity and a search is made for an element type associated with the Identity element in a step 1001. No element type for Identity is found in the element association repository (Table 3) and the find concept routine of FIG. 6 is performed in the step 1005. In FIG. 6, the lack of an element type is recognized in the step 601. There is a No result in the decision step 605 and the records associated with the message type in the element association repository looked up in the step 610. In the loop 612, the search of successive records in the element association repository of the step 620 finds a match between the Identity element and the element locator /CreditCheck Request/Identity. The concept item Pers_Id is then retrieved from the element association repository in the step 623. Control is then returned to a step 1010 in which the concept read routine of FIG. 11 for the “Identity” element opening is performed. No content data is found for the Identity element opening in the read data step 1101. Although the found concept item Pers_Id of step 1105 has an integrity requirement (Table 4) which is to be applied to all sub-elements of the Identity element, there is no data for validation of digital signature for the Identity element opening. Also, there is no privacy requirement for the concept item in step 1120. As a result, control is returned to the receive element security processing of FIG. 10 without modification and there is no element opening writing in step 1015.

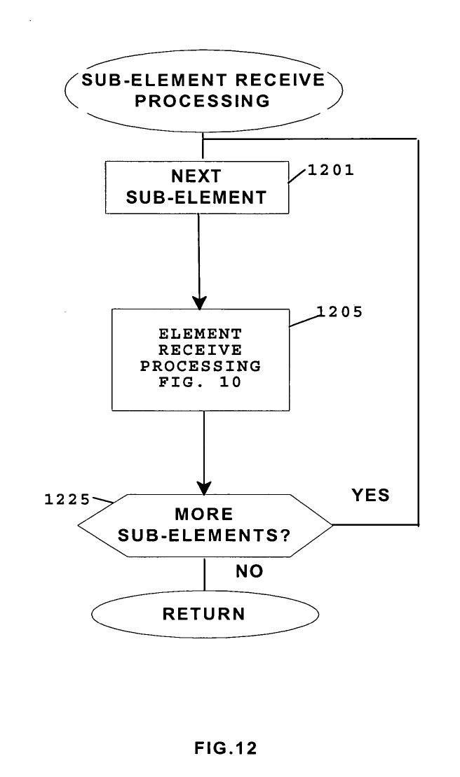

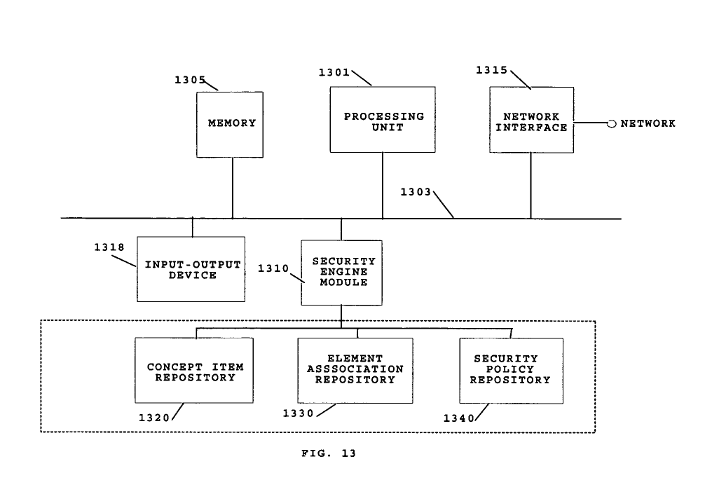

Since the Identity element has sub-elements Name, Address and SSN and the sub-elements Street, City, State and Zip for the sub-element Address, the receive sub-element processing routine of FIG. 12 is entered through decision step 1020. In FIG. 12, the Name sub-element is addressed in step 1201. The element receive processing of FIG. 10 is then performed for the Name sub-element according to the element receive processing of FIG. 10 (step 1205). In the processing of FIG. 10, no sub-element type is obtained from the element association repository in step 1001. The find concept item routine of FIG. 6 is invoked in step 1005 in which no match with an element locator is found in a search of the element association repository. Control is then passed to a sub-element concept read step 1010 which calls the concept read routine of FIG. 11 for the sub-element Name opening. The processing proceeds as previously described for the Identity element. Since there is no concept item for the sub-element name opening, content or closing, the sub-element Name does not have any unique integrity or privacy requirement in the concept read processing of FIG. 11. Similarly, there are no entries in the element association repository for the sub-elements Street, City, State and Zip of the Address sub-element and no unique operations are performed for these sub-elements in routine of FIG. 10.

Control is then returned to step 1201 through step 1225 and the next sub-element of the message type CreditCheckRequest, SSN, is addressed. In the processing of the sub-element SSN, a match is found with the element locator /CreditCheck/Identity/SSN in the step 620 and the concept item Soc-Sec is retrieved in the step 623. During the concept read routine of FIG. 11 for the SSN element, the Soc_Sec concept item is found in the step 1105. The ssn security policy record associated with the Soc-Sec concept item in the security policy repository requires privacy so that the SSN element is decrypted in the step 1125 of FIG. 11 and the decrypted content of the SSN element is written to the message terminal in the step 1035. XML Encryption may be used for the decryption processing. No more sub-elements are found for the Identity element in the decision step 1225 and control is returned to the step 1030 in which the content of the Identity element is read.

The concept read for the content of the Identity element including all of its sub-elements is performed in FIG. 11 for the step 1030. As indicated for the PI (personal identity) record in the security policy repository, only integrity processing is required for the concept item Pers_ID. In the concept read processing for the Identity” element including its sub-elements, the validate signature step 1115 is entered from the integrity required decision step 1110 and the digital signature for the entire Identity element content including the content of its sub-elements Name, Address and SSN and the sub-elements of the Address sub-element Street, City, State and Zip is validated in step 1115. XML Signature may be used to provide validation. The validated data is then written to the message terminal for outputting by the input-output device 1318 of FIG. 13 in the step 1035.

After the write for the Identity element content in the step 1035, the element closing of the Identity element is concept read in step 1040. Since there is no content to the Identity element closing, no action is taken in FIG. 11 for the concept read of the identity element closing in the step 1040. Control is returned to decision step 910 in FIG. 9 and the receive element security processing of FIG. 10 is reentered for the element “Payment” in the CreditCheckRequest message. The “Payment” element is of the xsd element type “CreditCard” which is associated with the concept item Chrg_Det in the CreditCheckRequest message type. The element type CreditCard is obtained in the step 1001. In the find concept item of FIG. 6 for the step 1005, the element type CreditCard is found in the step 605 and the associated concept item Chrg_Det is retrieved in the step 623 from the element association repository (Table 3). Control is then passed to the step 1010 in FIG. 10.

The concept read routine of FIG. 11 is performed on the Payment element opening in the step 1010. Since there is no content for the Payment element opening, no security processing is performed in FIG. 11 or in the element write step 1015. The sub-elements Name, Number, Type and Expiry of the Payment element are found in the decision step 1020. The receive processing for these sub-elements is then performed in FIG. 12 for the step 1025. None of the sub-elements Name, Number, Type and Expiry has an element type or an associated concept item in the element association repository and privacy or integrity processing is done for these sub-elements in the element receive processing routine of FIG. 10 called in FIG. 12. After processing the last sub-element Expiry, control is returned to the step 1030 through the decision step 1225 and the content of the Payment element, i.e., that of the sub-elements Name, Number, Type and Expiry is read in the routine of FIG. 11 for the step 1030. The data of the Payment element is read in the step 1101 and concept element find routine of FIG. 6 is entered in the step 1105. The concept type Chrg_Det is found in the step 605 for which the associated security policy for the element type CreditCard in the security policy repository requires both privacy and integrity. The step 1115 is entered through the decision step 1110 and the data in the sub-elements Name, Number, Type and Expiry is processed for validation. The step 1125 is then entered through the decision step 1120 and the data of the sub-elements Name, Number, Type and Expiry is decrypted in the step 1125. The resulting validated and decrypted data is then written (step 1035) to the message terminal for outputting by input-output device 1318 and control is returned to the step 1040 in FIG. 10.

After the write for the “Payment” element content in the step 1135, the element closing of the Payment element is concept read in a step 1140. Absent content in the “Payment” element closing, security type processing is done in FIG. 11 for the concept read of the “Payment” element closing and control is returned to a decision step 910 in FIG. 9. No other elements are detected in the decision step 910 and the clear message is output by the input-output device 1318 in step 915 of FIG. 9.

While the invention has been described by way of a particular illustrative embodiment, it is to be understood that the invention is not limited to the above-described embodiments but that those of ordinary skill in the art may make various changes and modifications without departing from the scope and spirit of the invention. Accordingly, the foregoing embodiments should not be construed as limiting the scope of the invention, which is encompassed instead by the following claims.

1. A message communication method comprising:
forming a plurality of message elements for a message type;
generating a plurality of concept items;
identifying one or more of the message elements with each concept item;
assigning a security policy to each concept item; and
processing each message element of a message identified with one of the concept items according to the security policy assigned to the identified concept item.

2. A message communication method according to claim 1 wherein the message elements of a predetermined type are identified with one of the concept items.

3. A message communication method according to claim 1 wherein each security policy assigned to a concept item includes one or more security commands and the processing of each message element includes modifying the message element according to the security commands of the security policy assigned to the concept item.

4. A message communication method according to claim 3, wherein the security commands include a privacy command, an integrity command and a no-action command.

5. A message communication method according to claim 1, wherein the identifying of the message elements with one of the concept items is performed independently of the assigning of a security policy to the one concept item.

6. A message communication method according to claim 2, wherein the identifying of the message elements with one of the concept items is performed independently of the assigning of a security policy to the one concept item.

7. A message communication method according to claim 3, wherein the identifying of the message elements with one of the concept items is performed independently of the assigning of a security policy to the one concept item.

8. A message communication method according to claim 4, wherein the identifying of the message elements with one of the concept items is performed independently of the assigning of a security policy to the one concept item.

9. A message communication method according to claim 1, wherein the assigning of a security policy to one of the concept items is performed without reference to the identification of message elements to the concept item.

10. A message communication method according to claim 1, wherein the identification of a message element with one of the concept items is performed without reference to the assigning of a security policy to the one concept item.

11. A message communication method according to claim 1 wherein the security policy includes at least a privacy command and an integrity command; and
the processing of each message element for transmission over a network comprises:
determining the concept item identified with the message element;
encrypting the message element in response to a privacy command in the security policy assigned to the concept item identified with the message element; and
digitally signing the message element in response to an integrity command in the security policy assigned to the concept item identified with the message element.

12. A message communication method according to claim 1 wherein the security policy includes at least a privacy command and an integrity command; and
the processing of each message element received from a network comprises:
determining the concept item identified with the message element;
validating the digital signature of the message element in response to an integrity command in the security policy assigned to the concept item identified with the message element; and
decrypting the message element in response to a privacy command in the security policy assigned to the concept item identified with the message element.

13. A message communication method according to claim 1, wherein one or more of the message elements has one or more message sub-elements, and
each message sub-element for a message element identified with one of the concept items is processed according to the security policy assigned to the one concept item for the identified message element.

14. Message communication apparatus comprising:
a message element former for forming a plurality of message elements for a message type;
a concept item generator for generating a plurality of concept items;
a message element identifier for identifying one or more of the message elements with each concept item;
a security policy assignor for assigning a security policy to each concept item; and
a security engine responsive to the security policy assigned to the identified concept item for processing each message element identified with one of the concept items.

15. Message communication apparatus according to claim 14, wherein the message element identifier identifies the message elements of a predetermined type with one of the concept items.

16. Message communication apparatus according to claim 14, wherein each security policy assigned to one of the concept items includes one or more security commands and the security engine includes a message modifier responsive to the security commands of the security polity assigned to the concept item identified with a message element for modifying the message element.

17. Message communication apparatus according to claim 16, wherein the security commands include a privacy command, an integrity command and a no-action command.

18. Message communication apparatus according to claim 14, wherein the message element identifier identifies the message elements with one of the concept items independently of the security policy assignor assigning a security policy to the one concept item.

19. Message communication apparatus according to claim 15, wherein the message element identifier identifies the message elements with one of the concept items independently of the security policy assignor assigning a security policy to the one concept item.

20. Message communication apparatus according to claim 16, wherein the message element identifier identifies the message elements with one of the concept items independently of the security policy assignor assigning a security policy to the one concept item.

21. Message communication apparatus according to claim 17, wherein the message element identifier identifies the message elements with one of the concept items independently of the security policy assignor assigning a security policy to the one concept item.

22. Message communication apparatus according to claim 14, wherein the security policy assignor assigns a security policy to one of the concept items without reference to the identification of message elements to the one concept item by the message element identifier.

23. Message communication apparatus according to claim 14, wherein the message element identifier identifies a message element with one of the concept items without reference to the assigning of security policies to the one concept item.

24. Message communication apparatus according to claim 14, wherein the security policy includes at least a privacy command and an integrity command; and
the security engine includes a security processor for processing each message element for transmission over a network that comprises:
a determining unit for determining the concept item identified with the message element;
an encrypting unit for encrypting the message element in response to a privacy command in the security policy assigned to the concept item identified with the message element; and
a signing unit for digitally signing the message element in response to an integrity command in the security policy assigned to the concept item identified with the message element.

25. Message communication apparatus according to claim 14, wherein the security policy includes at least a privacy command and an integrity command; and
the security engine includes a security processor for processing of each message element received from a network that comprises:
a determining unit for determining the concept item identified with the message element; and
a validating unit for validating the digital signature of the message element in response to an integrity command in the security policy assigned to the concept item identified with the message element; and
a decrypting unit for decrypting the message element in response to a privacy command in the security policy assigned to the concept item identified with the message element.

26. Message communication apparatus according to claim 14, wherein one or more of the message elements has one or more message sub-elements, and
the security engine processes each message sub-element according to the security policy assigned to the concept item for the identified message element.

27. A computer software product, tangibly stored on a computer-readable medium comprising instructions operable to cause a programmable processor to:
form a plurality of message elements for a message type;
generate a plurality of concept items;
identify one or more of the message elements with each concept item;
assign a security policy to each concept item; and
process each message element identified with one of the concept items according to the security policy assigned to the identified concept item.

28. A computer software product according to claim 27, wherein the message elements of a predetermined type are identified with one of the concept items.

29. A computer software product according to claim 27, wherein each security policy assigned to one of the concept items includes one or more security commands and the processing of each message element includes modifying the message element according to the security commands of the security policy assigned to the one concept item.

30. A computer software product according to claim 29, wherein the security commands include a privacy command, an integrity command and a no-action command.

31. A computer software product according to claim 27, wherein the identifying of the message elements with one of the concept items is performed independently of the assigning of a security policy to the one concept item.

32. A computer software product according to claim 28, wherein the identifying of the message elements with one of the concept items is performed independently of the assigning of a security policy to the one concept item.

33. A computer software product according to claim 29, wherein the identifying of the message elements with one of the concept items is performed independently of the assigning of a security policy to the one concept item.

34. A computer software product according to claim 30, wherein the identifying of the message elements with one of the concept items is performed independently of the assigning of a security policy to the one concept item.

35. A computer software product according to claim 27, wherein the security policy is assigned to one of the concept items without reference to the identification of message elements with the one concept item.

36. A computer software product according to claim 27, wherein the message element is identified with one of the concept items without reference to the assigning of security policies to the one concept item.

37. A computer software product according to claim 27, wherein the security policy includes at least a privacy command and an integrity command; and
the instructions for processing of each message element for transmission over a network includes instructions operable to cause the programmable processor to:
determine the concept item identified with the message element;
encrypt the message element in response to a privacy command in the security policy assigned to the concept item identified with the message element; and
digitally sign the message element in response to an integrity command in the security policy assigned to the concept item identified with the message element.

38. A computer software product according to claim 27, wherein the security policy includes at least a privacy command and an integrity command; and
the instructions for processing of each message element received from a network includes instructions operable to cause the programmable processor to:
determine the concept item identified with the message element;
validate the digital signature of the message element in response to an integrity command in the security policy assigned to the concept item identified with the message element; and
decrypt the message element in response to a privacy command in the security policy assigned to the concept item identified with the message element.

39. A computer software product according to claim 27, wherein one or more of the message elements has one or more message sub-elements, and
the instructions for processing each message element includes instructions for processing each message sub-element for a message element identified with one of the concept items according to the security policy assigned to the concept item for the identified message element.

40. A security engine for a communication apparatus comprising:
a first repository for storing a plurality of concept items;
a second repository for storing an identification of one or more message elements with one of the concept items;
a third repository for storing a security policy assigned to each of the concept items;
a processor for processing each message element identified with one of the concept items according to the security policy assigned to the identified concept item.

41. A security engine according to claim 40, wherein the message elements of a predetermined type are identified to one of the concept items.

42. A security engine according to claim 40, wherein each security policy assigned to one of the concept items includes one or more security commands and the processor that processes a message element includes a modifying unit for modifying the message element identified with the one concept item according to the security commands of the security policy assigned to the one concept item.

43. A security engine according to claim 42, wherein the security commands include a privacy command, an integrity command and a no-action command.

44. A security engine according to claim 40, wherein the identification of the message elements stored in the second repository with one of the concept items is performed independently of the assignment of the security policy for the one concept item stored in the third repository.

45. A security engine according to claim 41, wherein the identification of the message elements stored in the second repository with one of the concept items is performed independently of the assignment of the security policy for the one concept item stored in the third repository.

46. A security engine according to claim 42, wherein the identification of the message elements stored in the second repository with one of the concept items is performed independently of the assignment of the security policy for the one concept item stored in the third repository.

47. A security engine according to claim 43, wherein the identification of the message elements stored in the second repository with one of the concept items is performed independently of the assignment of the security policy for the one concept item stored in the third repository.

48. A security engine according to claim 40, wherein the assignment of a security policy to the concept items is performed without reference to the identification of message elements with the concept items.

49. A security engine according to claim 40, wherein the identification of message elements with the concept items is performed without reference to the assignment of security policies to concept items.

50. A security engine according to claim 40, wherein the security policy includes at least a privacy command and an integrity command; and the processor includes a security processor for processing of each message element for transmission over a network that comprises:
a determining unit for determining the concept item identified with the message element;
an encrypting unit for encrypting the message element in response to a privacy command in the security policy assigned to the concept item identified with the message element; and
a signing unit for digitally signing the message element in response to an integrity command in the security policy assigned to the concept item identified with the message element.

51. A security engine according to claim 40, wherein the security policy includes at least a privacy command and an integrity command; and the processor includes a security processor for processing of each message element received from a network that comprises:
a determining unit for determining the concept item identified with the message element;
a validating unit for validating the digital signature of the message element in response to an integrity command in the security policy assigned to the concept item identified with the message element; and
a decrypting unit for decrypting the message element in response to a privacy command in the security policy assigned to the concept item identified with the message element.

52. A security engine according to claim 40, wherein one or more of the message elements has one or more message sub-elements, and the processor processes each message sub-element according to the security policy assigned to the concept item for the identified message element.
